(19) United States
(12) Patent Application Publication
(10) Pub. No.: US 2003/0122058 A1
(43) Pub. Date: Jul. 3, 2003

(54) Image-sensing method and device

(76) Inventors: Yaomin Lin, Hsinchu (TW); Ying-Cheun Spring Yeh, Taoyuan (TW); Chih-Wei Chi, Taipei (TW); Hau-Wei Wang, Taipei (TW)

Correspondence Address: BIRCH STEWART KOLASCH & BIRCH, PO BOX 747, FALLS CHURCH, VA, 22040-0747, US

(21) Appl. No.: 10/327,886

(22) Filed: Dec. 26, 2002

(30) Foreign Application Priority Data
Dec. 27, 2001 (TW) 90132615

(51) Int. Cl. H01J 40/14

(52) U.S. Cl. 250/214 B

(57) ABSTRACT

An image-sensing method uses a modulated light as the light source. The image sensing method comprises the steps of using the modulated light to a sample to generate a modulated light signal, transmitting the modulated light signal to a light sensing element to convert the modulated light signal to an AC image signal, transmitting the AC image signal to an AC/DC conversion circuit to convert the AC image signal to a DC image signal according to the modulation frequency of the modulated light and forming the DC image signal. The image-sensing method effectively prevents interference of stray light and electronic noise.

### BACKGROUND OF THE INVENTION

1. Field of the Invention

The present invention relates to an image sensing method and device, and in particular to an image-sensing method and device using modulated light and eliminating the influence of the stray light to enhance the signal-to-noise ratio of the weak image signal of a sample.

2. Description of the Related Art

Referring to FIG. 1, a conventional image-sensing device receives a continuous spectrum by an integrating method. After the continuous spectrum is input to the conventional image-sensing device, it is converted to an electronic signal of electric current or voltage. Then, the electronic signal is transmitted to an analog/digital converter in series.

Nevertheless, the continuous spectrum received by the conventional image-sensing device may be composed of the real signal light and stray light. When the weak spectrum of a sample exists in the continuous spectrum, the image signal converted from the weak spectrum is covered by that converted from the stray light. Thus, the optical image of the sample is not easily measured.

### SUMMARY OF THE INVENTION

An object of the invention is to provide an image-sensing method using modulated light. The method comprises the steps of: illuminating the modulated light to a sample to generate a modulated light signal; transmitting the modulated light signal to a light sensing element to convert the modulated light signal to an AC image signal; and transmitting the AC image signal to an AC/DC conversion circuit to convert the AC image signal to a DC image signal according to the modulation frequency of the modulated light and outputting the DC image signal.

Another object of the invention is to provide an image-sensing device using modulated light. The device comprises a modulation light source and an image sensing element. The modulation light source generates the modulated light having a modulation frequency. The modulated light generates a modulated light signal after it illuminates on the sample. The image sensing element has an AC/DC conversion circuit. The image sensing element detects the modulated light signal and converts the modulated light signal to an AC image signal. The AC image signal is converted to a DC image signal according to the modulation frequency of the modulation light source.

Preferably, the AC/DC conversion circuit is a substrator.

Preferably, the noise and interference of the AC image signal are eliminated by the substrator to enhance the signal-to-noise ratio thereof. Thus, the image-sensing method and device can measure the weak optical image of the sample under stray light.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a conventional image-sensing device;

FIG. 2 is a schematic view showing the image-sensing device of the invention using modulated light;

FIG. 3A is a schematic view for the un-modulated DC light signal before passing through the light modulation device of the invention;

FIG. 3B is a schematic view showing the modulated light signal after light passes through the light modulation device of the invention; and

FIG. 4 is a circuit block diagram of the image sensing element of the invention.

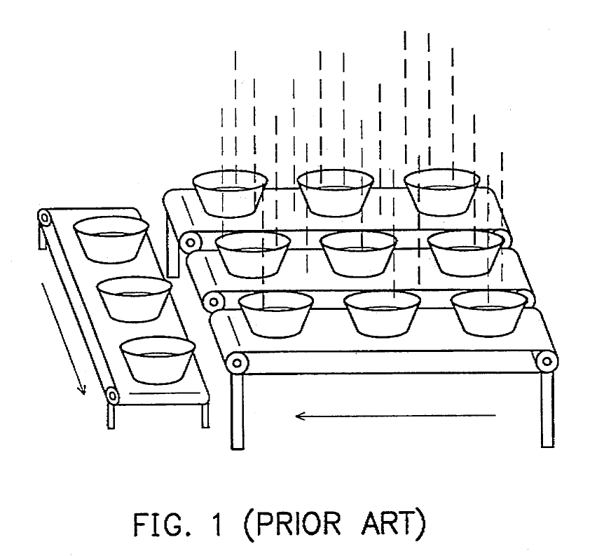

### DETAILED DESCRIPTION OF THE INVENTION

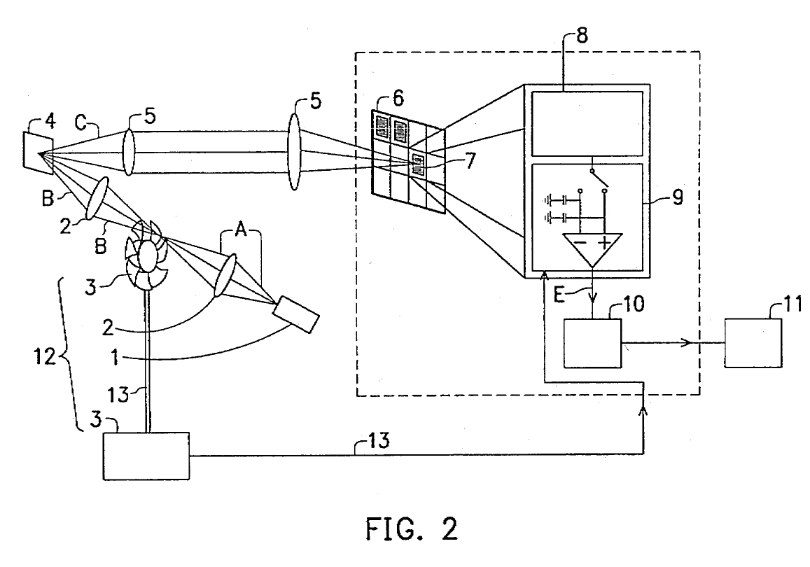

Referring to FIG. 2, the image-sensing device comprises a modulation light source 12 and an image sensing element 6. The modulation light source 12 has a light source 1 and a light modulation device 3. When the light source 1 generates light A to the light modulation device 3, the light modulation device 3 generates modulation light B having a modulation frequency f_{M}.

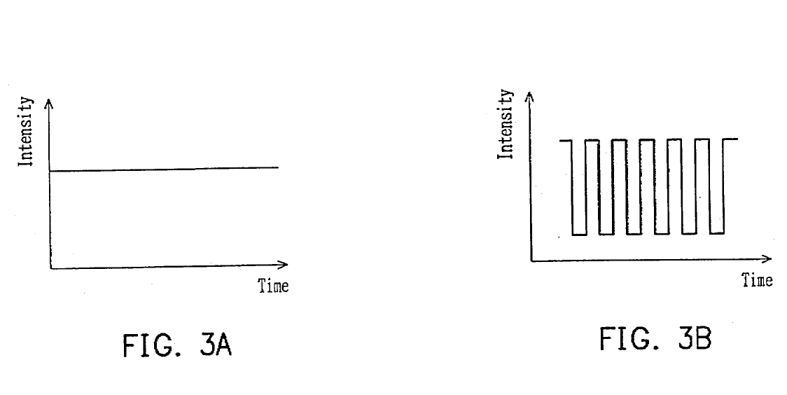

FIG. 3A is a schematic view for the un-modulated DC light signal before light A passes through the light modulation device 3. FIG. 3B is a schematic view showing the modulated light signal after light A passes through the light modulation device 3. The light modulation device 3 can be a rotating light-modulation chopper. The rotating light-modulation chopper rotates at the modulation frequency f_{M} and generates modulation light B having the modulation frequency f_{M}. Additionally, the light modulation device 3 may use a liquid crystal panel to generate the modulation frequency of the modulation light B to control opening and closing of a liquid crystal light valve (not shown). The image sensing element 6 has a plurality of pixels 7. Each pixel 7 has a light sensing element 8, an amplifying circuit (not shown) and an AC/DC conversion circuit 19.

As shown in FIG. 2, the modulation light B is illuminating on a sample 4 via a lens 2. The modulation light B reflecting or emitting from the sample 4 forms a modulated light signal C. The modulated light signal C passes through an optical imaging module 5 and enters the pixel 7 of the image sensing element 6. Additionally, the light modulation device 3 also outputs a synchronous signal 13 having the same frequency as the modulation light B to the image sensing element 6. The pixel 7 of the image sensing element 6 detects the modulated light signal C at the modulation frequency.

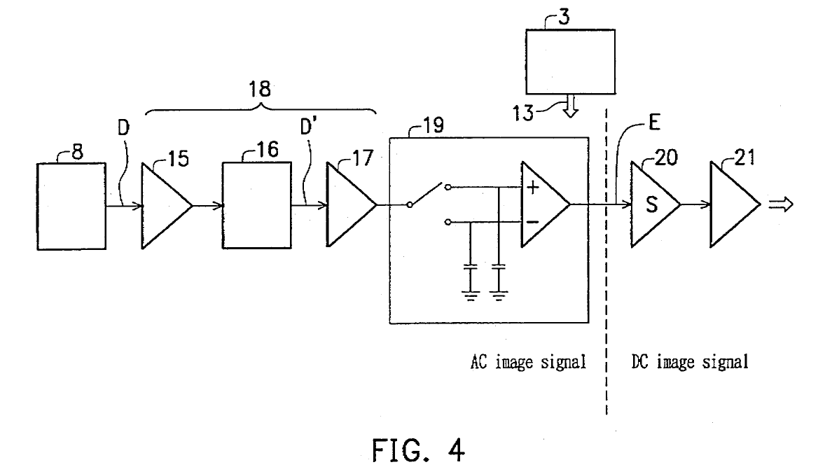

Referring to FIG. 4, the pixel 7 contains a light sensing element 8, an amplifying circuit 18 and an AC/DC conversion circuit 19. The amplifying circuit 18 further includes a pre-amplifier 15, a band pass filter 16 and an amplifier 17. When the modulated light signal C enters the light sensing element 8, the light sensing element 8 generates an AC image signal D. The AC image signal D is amplified by the pre-amplifier 15. After the amplified AC image signal D passing through the band pass filter 16, an AC image signal D′ at a predetermined frequency is sampled and other signals not having the band pass frequency are removed. Then, the AC image signal D′ is amplified by the amplifier 17. The amplified AC image signal D′ enters the AC/DC conversion circuit 19, such as a substrator. The AC image signal D′ is converted to a DC image signal E by the substrator according to the synchronous signal 13 from the light modulation device 3. In this embodiment, the maximum and the minimum of the AC image signal D′ are subtracted from each other to eliminate noise and interior circuit interference.

As mentioned above, the DC image signal E enters an integrating circuit 20. The integrating circuit 20 integrates the DC image signals E during a predetermined period. Then, the DC image signals E are amplified by a DC amplifier 21 and output to an external processing device 11.

While the invention has been described by way of examples and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image-sensing method using modulated light, comprising the steps of:
illuminating a modulated light to a sample to generate a modulated light signal;
transmitting the modulated light signal to a light sensing element to convert the modulated light signal to an AC image signal; and
transmitting the AC image signal to an AC/DC conversion circuit to convert the AC image signal to a DC image signal at the modulation frequency of the modulated light and generating a DC image signal.

2. The image-sensing method using modulated light as claimed in claim 1, further comprising the steps of:
amplifying the AC image signal from the light sensing element by a pre-amplifier;
transmitting the AC image signal amplified by the pre-amplifier at a predetermined frequency to a post-amplifier via a band pass filter and removing other signals not having the band pass frequency; and
amplifying the AC image signal at the predetermined frequency by the post-amplifier and transmitting the AC image signal amplified by the post-amplifier to the AC/DC conversion circuit.

3. The image-sensing method using modulated light as claimed in claim 1, further comprising the steps of:
integrating the DC image signals during a predetermined period by an integrating circuit; and
amplifying the DC image signals from the integrating circuit by a DC amplifier and transmitting the amplified DC image signals to a monitor.

4. The image-sensing method using modulated light as claimed in claim 1, further comprising the steps of:
generating light from a light source; and
transmitting the light to a light modulation device and generating the modulated light, wherein the modulated light has a modulation frequency.

5. The image-sensing method using modulated light as claimed in claim 1, wherein the AC/DC conversion circuit is a subtracting device.

6. The image-sensing method using modulated light as claimed in claim 4, wherein the light modulation device is a rotating light-modulation chopper.

7. The image-sensing method using modulated light as claimed in claim 4, wherein the light modulation device is a liquid crystal panel.

8. An image-sensing device using modulated light, comprising:
a modulation light source generating the modulated light at a modulation frequency, the modulated light generating a modulated light signal after it illuminates on a sample; and
an image sensing element having an AC/DC conversion circuit, the image sensing element detecting the modulated light signal and converting the modulated light signal to an AC image signal, the AC image signal is converted to a DC image signal according to the modulation frequency of the modulation light source.

9. The image-sensing device using modulated light as claimed in claim 8, wherein the modulation light source further comprises a light source and a light modulation device, the light source generating light, the light modulation device converting the light to the modulated light at the modulation frequency.

10. The image-sensing device using modulated light as claimed in claim 9, wherein the light modulation device is a rotating light-modulation chopper.

11. The image-sensing device using modulated light as claimed in claim 9, wherein the light modulation device is a liquid crystal panel.

12. The image-sensing device using modulated light as claimed in claim 8, wherein the image sensing element further comprises a light sensing element, a pre-amplifier, a band pass filter, a post-amplifier and an AC/DC conversion circuit, the light sensing element detecting the modulated light signal and generating the AC image signal, the pre-amplifier amplifying the AC image signal from the light sensing element, the band pass filter generating the AC image signal from the pre-amplifier at a predetermined frequency and removing other signals not having the band pass frequency, the post-amplifier amplifying the AC image signal from the band pass filter, the AC/DC conversion circuit converting the AC image signal to the DC image signal according to the modulation frequency of the modulation light source.

13. The image-sensing device using modulated light as claimed in claim 12, wherein the AC/DC conversion circuit is a substrator, and the maximum and the minimum of the AC image signal are subtracted from each other to form the DC image signal at the modulation frequency of the modulation light source.

14. The image-sensing device using modulated light as claimed in claim 12, further comprising an integrating circuit and a DC amplifier, the integrating circuit integrating the DC image signals during a predetermined period, and the DC amplifier amplifying the DC image signals from the integrating circuit and transmitting the amplified DC image signals to an external processing device.
